(19) United States
(12) Patent Application Publication
(10) Pub. No.: US 2019/0330059 A1
(43) Pub. Date: Oct. 31, 2019

(54) BORON-CONTAINING CATALYSTS FOR DRY REFORMING OF METHANE TO SYNTHESIS GAS

(71) Applicant: King Abdullah University of Science and Technology, Thuwal (SA)

(72) Inventors: Kazuhiro TAKANABE, Thuwal (SA); Jean-Marie BASSET, Thuwal (SA); Jung-Hyun PARK, Thuwal (SA); Akshaya SAMAL, Thuwal (SA); Bedour ALSABBAN, Thuwal (SA)

(21) Appl. No.: 16/312,149

(22) PCT Filed: Jun. 24, 2017
(86) PCT No.: PCT/IB2017/053784

§ 371 Date: Dec. 20, 2018

Related U.S. Application Data
(60) Provisional application No. 62/355,427, filed on Jun. 28, 2016.

(51) Int. Cl. C01B 3/40; B01J 23/75; B01J 23/83; B01J 21/02; B01J 37/02; B01J 37/18; B01J 37/08

(52) U.S. Cl. CPC C01B 3/40; B01J 23/75; B01J 23/83; B01J 21/02; B01J 37/0205; C01B 2203/1241; B01J 37/0236; B01J 37/08; C01B 2203/0238; C01B 2203/1052; C01B 2203/1082; B01J 37/18

(57) ABSTRACT

The present invention uses a cobalt catalyst for carbon dioxide reforming of lower alkanes to synthesis gas having a cobalt catalyst on an oxide support where the supported cobalt catalyst has been modified with a boron precursor. The boron-treated cobalt catalyst systems as described herein show significant increases in the conversion of CH₄ and CO₂ during the dry reforming of methane (DRM) reaction as compared to traditional catalysts. Described herein are supported catalysts and methods of using the catalysts for the dry reforming of methane to synthesis gas, with the supported catalysts in the present invention include a boron-treated cobalt catalyst disposed on an oxide support. Also described herein are processes for preparing the supported catalysts.

### RELATED APPLICATION DATA

This application claims the benefit of U.S. Provisional Patent Application Ser. No. 62/355,427, filed Jun. 28, 2016.

### TECHNICAL FIELD

The present invention relates generally to catalysts used for dry reforming methane gas to carbon monoxide and hydrogen gases.

### BACKGROUND OF THE INVENTION

The background of this invention will address general topics involving methane gas, dry reforming of methane and catalysts.

Methane Gas

Methane (CH₄) is a colorless, odorless, flammable gas produced mainly by microbial methanogenesis in the decomposition of biomass. Methane was first scientifically identified in the marshes of Lake Maggiore by Italian physicist Alessandro Volta, who was inspired by a paper about “flammable air” written by Benjamin Franklin. Volta isolated methane from the marsh gas and demonstrated its flammability. Since that time, abundant sources of methane gas have been found, and methane has become valued as an alternative energy source.

Methane is produced naturally in the anaerobic decomposition of biomass, including manure, livestock waste, landfill waste, wastewater sludge, paper mill sludge, and other biodegradable materials, such as deadfall in wetlands as studied by Volta. The methane produced by these processes are the primary sources of methane emissions into the atmosphere. When released into the atmosphere, methane constitutes one of the primary greenhouse gases in the Earth's atmosphere.

Large deposits of methane are located in natural gas fields below ground and under the ocean floor throughout the world. Methane is extracted from gas fields in large quantities and used widely in applications ranging from its use as a domestic heating and cooking fuel to its use in the large scale production of electricity in power plants. Compared to most other fuels, methane is clean burning, producing only carbon dioxide and water as byproducts.

Methane (CH₄) is the predominant component of natural gas and a major part of the energy market today. Methane gas is abundant and is enormously valuable as a fuel for numerous purposes. But, there has been limited success in making methane the preferred default fuel source for vehicles and home use, especially in areas where liquid petroleum fuels are abundant, preferred or required.

For instance, in portable or mobile applications (such as vehicles), the wide-spread use of methane gas a primary fuel source has significant drawbacks compared to other fuel sources because the methane gas must be highly compressed to decrease the volume and stored under pressure in thick-walled tanks to maintain the gas in the compressed state. While pressurizing technologies are available, these related technologies are not sufficiently economical or efficient to support methane substitution for liquid petroleum fuels. As a result, methane gas has not overtaken the popularity of liquid hydrocarbon fuels, which are presently the most common fuels used for vehicles and other mobile applications.

A process for turning gases, such as methane, into liquid fuels was first developed by Franz Fischer and Hans Tropsch at the Kaiser-Wilhelm-Institut für Kohlenforschung in Mülheim an der Ruhr, Germany, in 1925. In Fischer-Tropsch synthesis, a series of controlled chemical reactions turn gaseous carbon monoxide (CO) and hydrogen (H₂) into liquid hydrocarbons usable as synthetic fuels. The CO and H₂ used in the process are typically sourced from methane, and those sourced gases can be used as a fuel source.

Methane can also be produced by industrial processes either incorporating forced reduction of biomass, or by synthetic processes, such as hydrogenating carbon dioxide, production of fossil fuels, and as a byproduct of chemical reactions. Synthetic hydrocarbon fuels produced via the Fischer-Tropsch process can be used in the same manner as liquid fuels like gasoline and diesel with the added advantage of being cleaner burning fuels. None of these existing processes have led to the sufficiently economical and efficient commercial production of methane and none of these processes have resolved the long-standing issues related to the inefficiencies of economically producing methane gas on a commercial scale.

Numerous reactions have been investigated to convert methane into valuable chemical intermediates in the chemical industry through partial oxidation of methane, steam and carbon dioxide reforming, and other processes. These investigations, however, have been met with very limited success, and none of these investigations have led to the sufficiently economical and efficient commercial production of methane or intermediaries. Current systems and processes have presently not resolved the problems associated with, and the inefficiencies related to, the commercial scale production and use of methane gas as a primary fuel source.

Dry Reforming of Methane

Methane and carbon dioxide (CH₄ and CO₂) are abundant carbon sources. Carbon dioxide reforming of methane, also known as dry reforming of methane (DRM), is a process that converts methane and carbon dioxide (CH₄ and CO₂) into one or more synthesis gases (i.e., carbon monoxide (CO) and hydrogen (Hz)). The dry reforming of methane (DRM) reaction produces an equimolar ratio of CO and Hz, and the dry reforming of methane (DRM) reaction produces the chemical feedstock for synthesizing valuable hydrocarbons via Fischer-Tropsch (F-T) synthesis.

The dry reforming of methane (DRM) reaction is a strongly endothermic reaction (247 kJ mol⁻¹) as compared to steam reforming of methane (206 kJ mol⁻¹). In endothermic processes, energy must be absorbed from the surroundings, usually in the form of heat, in order for the reaction to proceed. The dry reforming of methane (DRM) reaction also requires high temperatures to achieve desirable CH₄ and CO₂ conversion and an equimolar Hz to CO ratio. To achieve high conversion of CH₄, the industrial operation is typically conducted at thermodynamic equilibrium.

The dry reforming of methane (DRM) reaction occurs according to the reaction scheme shown in Equation 1.

CH₄+CO₂↔2CO+2H₂, ΔH°_{298K}=247 kJ mol⁻¹ (Equation 1)

Side reactions that occur concurrently with the reaction in Equation 1 include the reverse water-gas shift reaction (RWGS, (Equation 2), methane decomposition (Equation 3), and the Boudouard reaction (Equation 4). The dry reforming of methane (DRM) reaction may be accompanied in parallel by many side reactions, such as those depicted in Equations 2-4 below.

CO₂+H₂↔CO+H₂O, ΔH°_{298K}=41 kJ mol⁻¹ (Equation 2)

CH₄↔C+2H₂, ΔH°_{298K}=75 kJ mol⁻¹ (Equation 3)

2CO↔C+CO₂, ΔH°_{298K}=−171 kJ mol₋₁ (Equation 4)

Methane decomposition (Equation 3) and the Boudouard reaction (Equation 4) are considered the main sources of undesired carbon deposition during the dry reforming of methane (DRM) reaction, the extent of which depends on the temperature and concentration of reactants. The thermodynamic analysis of these reactions indicates that carbon deposition is more prevalent in the temperature range from 773° K to 1073° K as opposed to other temperature ranges.

Carbon deposition on the catalyst can manifest itself in various forms, such as fouling on support, encapsulating carbon on the active metal, and carbon fiber/nanotube formation. Carbon deposition can cause the loss of active sites. However, carbon nanotube formation requires additional attention because, although it may not cause the deactivation of the catalyst for dry reforming of methane (DRM), it can result in the destruction of the catalyst pellet or blockage of the reactor. Therefore, most research efforts to date have been mainly focused on catalyst development for enhancement of catalyst life-span and resistance to carbon deposition. These research efforts have not solved the problems associated with the inefficiencies and unsatisfactory economics hindering the wide-spread commercial production and use of methane gas as a primary fuel source.

Most of the group VIII metals, Ni, Ru, Rh, Ir, Pt, and Co are active in the dry reforming of methane (DRM) reaction. Supported noble metals show high conversion and good resistance to carbon deposition. Economically, noble metals are not suitable for use in the dry reforming of methane (DRM) reaction because of their high cost and scarcity (low availability).

Ni-based catalysts have also been studied to reduce carbon deposition because they are affordable, readily available, and very active in the dry reforming of methane (DRM) reaction. However, catalyst deactivation caused by carbon deposition and metal sintering is a problem for supported Ni-based catalysts. Indeed, Ni is a commonly used catalyst for the formation of carbon nanotubes because of the rapid carbon deposition rate, which is the antithesis of the type of material that would be used to reduce carbon deposition.

Much of the research to develop catalysts with resistance to carbon deposition has been focused on using different types of supports and promoters, and the methods used to prepare the catalysts are also considered to affect the formation or deposition of carbon. These research efforts have not solved the problems associated with the inefficiencies and unsatisfactory economics hindering the wide-spread commercial production and use of methane gas as a primary fuel source.

Catalysts

Catalysts are substances that increase the rate of a chemical reaction without undergoing permanent chemical change in the process. A threshold amount of activation energy is required to start a chemical reaction, much the same as a spark is needed to start a fire. A catalyst works by providing an alternative route for a reaction to proceed by requiring a lower amount of activation energy than the non-catalyzed reaction route. The threshold energy barrier that must be overcome for the reaction to proceed is then lower in the catalyzed reaction than in the non-catalyzed reaction, allowing the reaction to proceed more rapidly.

Catalysts are of two general types—homogenous and heterogeneous. A homogenous catalyst is one where the catalyst is of the same phase as at least one of the reactants. A heterogeneous catalyst is in a phase that is different from any of the reactants.

Homogenous catalysts typically participate in one or more steps of the reaction mechanism, but are not part of the final product. The catalyst remains chemically unchanged after completion of the reaction.

An example of a homogeneous catalyst involves an aqueous homogeneous catalyst added to an aqueous solution of reactants. In this type of reaction, the catalyst interacts with the reactants forming intermediates, which are substances that react more rapidly than the original reactants. The intermediates increase the interaction that can take place between reactants by providing a reaction route that requires less activation energy than if the catalyst was not present.

Heterogeneous catalysts typically involve a solid catalyst with liquid or gaseous reactants. These catalysts work by bringing the reactants close enough to one another to increase the interaction rate. Usually this happens when one or more of the reactants becomes adsorbed onto the surface of the catalyst, allowing the reactants to get close enough to facilitate interaction.

An example of a heterogeneous catalyst is a catalytic converter in an automobile. Carbon monoxide is a toxic by-product of the combustion reaction taking place in a gasoline engine, and carbon monoxide can react spontaneously with oxygen to produce carbon dioxide; however, even though the reaction is spontaneous, the process is slow. A catalytic converter speeds up the conversion of CO to CO₂ process by providing a material (usually a metal, such as platinum) that attracts the gases to its surface. Once the carbon monoxide and oxygen are in close proximity on the surface of the catalytic material, the reaction to produce carbon dioxide can proceed more quickly, thereby reducing the amount of carbon monoxide exiting the exhaust system of the automobile.

Catalysts used for the carbon dioxide dry-reforming of methane (DRM) process are usually of the heterogonous type with a solid catalyst attracting gaseous reactants to the surface of the catalyst to facilitate interaction between the reactants. Supported cobalt catalysts have been considered as a potentially alternative catalysts for dry reforming of methane (DRM), but these have been found to be highly susceptible to deactivation. Cobalt catalysts show a tolerance to carbon deposition, but deactivate rapidly due to oxidation of the metallic cobalt rendering it inactive for the dry reforming of methane (DRM) reaction.

Trace amounts of noble metals, such as Pt and Ru, have occasionally been used to help maintain the metallic state of the cobalt, however, the high cost and limited availability of these noble metals are distinct disadvantages. An alternative catalyst composition that can effectively catalyze the dry reforming of methane (DRM) reaction, resist carbon deposition and remain stable during the reaction is needed.

The current research on dry reforming of methane catalysts has not solved the long-standing problems associated with high carbon deposition, catalyst deactivation, inactivation of the reaction, and there is no prior system or process that is known to have solved the long-standing problems associated with the inefficiencies and unsatisfactory economics hindering the wide-spread commercial production and use of methane gas as a primary fuel source.

### SUMMARY OF THE INVENTION

The present invention uses a cobalt catalyst for carbon dioxide reforming of lower alkanes to synthesis gas having a cobalt catalyst on an oxide support where the supported cobalt catalyst has been modified with a boron precursor. The boron-treated cobalt catalyst systems as described herein show significant increases in the conversion of CH₄ and CO₂ during the dry reforming of methane (DRM) reaction as compared to traditional catalysts. Described herein are supported catalysts and methods of using the catalysts for the dry reforming of methane to synthesis gas, and the supported catalysts in the present invention include a boron-treated cobalt catalyst disposed on an oxide support. Also described herein are processes for preparing the supported catalysts.

The amount of cobalt can be 0.4 wt % to 20 wt % based on the weight of the catalyst (e.g., from 2 wt % to 20 wt % based on the weight of the catalyst). The oxide support can be zirconium oxide, cerium oxide, aluminum oxide, magnesium oxide, hydrotalcite (Mg—Al—Oₓ), or titanium oxide. The oxide support comprises zirconium oxide (ZrO₂), cerium oxide, or mixtures these oxides. The boron precursor is sodium borohydride (NaBH₄), ammonium borohydride (NH₃BH₃), boric acid, or a combination thereof. The amount of boron can be from 0.001 wt % to 0.5 wt % based on the weight of the catalyst.

These catalysts systems described in the present invention exhibit excellent stability for an extended reaction time period, and the catalyst systems also exhibit resistance to carbon deposition and have an enhanced lifetime. The starting materials for preparing the boron-treated cobalt catalyst systems are readily available and are relatively inexpensive. Thus, the catalyst systems described herein are suitable scale-up catalysts for the carbon dioxide reforming of methane to synthesis gas on an industrial scale. The present invention solves many of the long-standing problems in dry reforming of methane catalysts, such as resolving the high levels of carbon deposition, catalyst deactivation, inactivation of the reaction, and the present invention solves the long-standing problems associated with the inefficiencies and unsatisfactory economics previously hindering the wide-spread commercial production and use of methane gas as a primary fuel source.

Also described herein are processes for the carbon dioxide reforming or steam reforming of lower alkanes to synthesis gas. For example, a process for carbon dioxide reforming of lower alkanes to synthesis gas includes contacting a feed stream having a gaseous lower alkane and carbon dioxide, with a supported cobalt catalyst. The contacting is performed at a temperature from 600° C. to 950° C. and a pressure from 1 bar to 30 bar to produce a synthesis gas having hydrogen and carbon monoxide.

Also disclosed are processes for preparing a supported catalyst. For example, a process for preparing a supported catalyst as described herein includes providing a support comprising an oxide, impregnating the oxide support with a solution having a cobalt salt, drying the cobalt impregnated oxide support at a temperature ranging from 60° C. to 150° C. to form a supported cobalt catalyst, treating the cobalt catalyst with a boron precursor selected from boric acid, sodium borohydride, ammonium borohydride, or mixtures of these, to form a boron-treated catalyst, and drying the boron-treated cobalt catalyst.

The supported cobalt catalyst can be prepared from an aqueous solution of cobalt nitrate hexahydrate (Co(NO₃)₂.6H₂O), cobalt (II) chloride hexahydrate (CoCl₂.6H₂O), or combinations of these. The supported cobalt catalyst can be Co/ZrO₂ (NaBH₄), Co/ZrO₂ (NH₃BH₃), Co/CeO₂ (NaBH₄), Co/CeO₂—ZrO₂ (NaBH₄) or a mixture these, and can further include Co/ZrO₂, Co/CeO₂ and/or Co/CeO₂—ZrO₂.

The supported cobalt catalyst is pretreated to reduce the catalyst prior to contacting the feed stream by heating the supported cobalt catalyst at temperatures of 600° C. to 900° C. for 30 minutes to 5 hours in 4%-10% hydrogen in argon. The gaseous lower alkane can comprise methane.

The process includes calcining (heat treating) the dried impregnated support to form the catalyst. The oxide is zirconium oxide. The solution can be an aqueous solution. The drying step is performed at a temperature of from 60° C. to 150° C., from 75° C. to 150° C., and/or the calcining step can be performed at a temperature of 450° C. to 1000° C. Treating the cobalt catalyst with the boron precursor includes stirring for 1-3 hours at 20° C. to 90°.

The process for producing the catalyst includes impregnating the support with a capping agent. Thus, the process for preparing a catalyst as described herein comprises providing a support comprising an oxide, wherein the support is impregnated with a solution comprising a cobalt salt and a surface capping agent. The process also includes treating the impregnated support with a boron precursor and drying the boron-treated impregnated support to form a catalyst.

The oxide is zirconium oxide, cerium oxide, or a mixture of the two oxides. The solution can be an aqueous solution. The surface capping agent can comprise 6-aminohexanoic acid (AHA) or cetyl trimethyl ammonium bromide (CTBA), or a combination thereof. The boron precursor comprises boric acid, sodium borohydride, ammonium borohydride, or a mixture of these. The drying step can be performed at a temperature from 60° C. to 150° C., from about 60° C. to 100° C.

The details of one or more embodiments are set forth in the description and drawings below. Other features, objects, and advantages will be apparent from the description and drawings, and from the claims.

### BRIEF DESCRIPTION OF THE DRAWINGS

The above, and other objects and advantages of the present invention will be understood upon consideration of the following detailed description taken in conjunction with the accompanying drawings, in which like reference characters refer to like parts throughout, and in which:

FIG. 1 is a schematic depicting the preparation of Co/ZrO₂ (NaBH₄) catalysts by the impregnation method.

FIG. 2 is a schematic depicting the preparation of Co/ZrO₂ (NaBH₄) or Co/ZrO₂ (NH₃BH₃) catalysts by the impregnation method in the presence of a surface capping agent.

FIG. 3A is a graph showing the percentage of CH₄ conversion during CO₂ reforming of methane reactions using a boron-treated catalyst and an untreated catalyst.

FIG. 3B is a graph showing the percentage of CH₄ and CO₂ conversion during CO₂ reforming of methane reaction using a boron-treated catalyst along with the H₂/CO ratio of the resulting product.

FIG. 4 shows X-ray powder diffraction plots for a boron-treated catalyst and an untreated catalyst.

FIG. 5 is a graph showing the percentage of CH₄ conversion during CO₂ reforming of methane reactions using boron-treated catalysts with a ZrO₂ support and an untreated catalyst.

FIG. 6 is a graph showing the percentage of CH₄ conversion during CO₂ reforming of methane reactions using boron-treated catalysts having varying amounts of Co and ratios of B to Co.

FIG. 7 shows transmission electron microscopy (TEM) images of boron-treated catalysts having varying amounts of Co and ratios of B to Co after pretreatment and before the dry reforming of methane (DRM) reaction.

FIG. 8 contains a TEM image of a boron-treated catalyst after the dry reforming of methane (DRM) reaction.

FIG. 9A is a graph showing the percentage of CH₄ conversion during CO₂ reforming of methane reactions using a boron-treated catalyst with a CeO₂ support and an untreated catalyst.

FIG. 9B is a graph showing the percentage of CH₄ conversion during CO₂ reforming of methane reactions using a boron-treated catalyst with a CeO₂—ZrO₂ support and an untreated catalyst

While the invention is susceptible to various modifications and alternative forms, specific embodiments thereof have been shown by way of example in the drawings and are herein described in detail. It should be understood that the description herein of specific embodiments is not intended to limit the invention to the particular forms disclosed, but on the contrary, the intention is meant to cover all modifications, equivalents, and alternatives falling within the spirit and scope of the invention as defined by the appended claims.

### DETAILED DESCRIPTION

The present invention uses a cobalt catalyst for carbon dioxide reforming of lower alkanes to synthesis gas having a cobalt catalyst on an oxide support where the supported cobalt catalyst has been modified with a boron precursor. The boron-treated cobalt catalyst systems as described herein show significant increases in the conversion of CH₄ and CO₂ during the dry reforming of methane (DRM) reaction as compared to traditional catalysts.

Described herein are supported catalysts and methods of using the catalysts for the dry reforming of methane to synthesis gas, and the supported catalysts in the present invention include a boron-treated cobalt catalyst disposed on an oxide support. Also described herein are processes for preparing the supported catalysts.

The amount of cobalt can be 0.4 wt % to 20 wt % based on the weight of the catalyst (e.g., from 2 wt % to 20 wt % based on the weight of the catalyst). The oxide support can be zirconium oxide, cerium oxide, aluminum oxide, magnesium oxide, hydrotalcite (Mg—Al—Oₓ), or titanium oxide. The oxide support comprises zirconium oxide (ZrO₂), cerium oxide, or mixtures these oxides. The boron precursor is sodium borohydride (NaBH₄), ammonium borohydride (NH₃BH₃), boric acid, or a combination thereof. The amount of boron can be from 0.001 wt % to 0.5 wt % based on the weight of the catalyst.

The supported cobalt catalyst can be prepared from an aqueous solution of cobalt nitrate hexahydrate (Co(NO₃)₂.6H₂O), cobalt (II) chloride hexahydrate (CoCl₂.6H₂O), or combinations of these. The supported cobalt catalyst can be Co/ZrO₂ (NaBH₄), Co/ZrO₂ (NH₃BH₃), Co/CeO₂ (NaBH₄), Co/CeO₂—ZrO₂ (NaBH₄) or a mixture these, and can further include Co/ZrO₂, Co/CeO₂ and/or Co/CeO₂—ZrO₂.

These catalysts systems described in the present invention exhibit excellent stability for an extended reaction time period, and the catalyst systems also exhibit resistance to carbon deposition and have an enhanced lifetime. The starting materials for preparing the boron-treated cobalt catalyst systems are readily available and are relatively inexpensive. Thus, the catalyst systems described herein are suitable scale-up catalysts for the carbon dioxide reforming of methane to synthesis gas on an industrial scale. The present invention solves many of the long-standing problems in dry reforming of methane catalysts, such as resolving the high levels of carbon deposition, catalyst deactivation, inactivation of the reaction, and the present invention solves the long-standing problems associated with the inefficiencies and unsatisfactory economics previously hindering the wide-spread commercial production and use of methane gas as a primary fuel source.

Also described herein are processes for the carbon dioxide reforming or steam reforming of lower alkanes to synthesis gas. For example, a process for carbon dioxide reforming of lower alkanes to synthesis gas includes contacting a feed stream having a gaseous lower alkane and carbon dioxide, with a supported cobalt catalyst. The contacting is performed at a temperature from 600° C. to 950° C. and a pressure from 1 bar to 30 bar to produce a synthesis gas having hydrogen and carbon monoxide

The supported cobalt catalyst is pretreated to reduce the catalyst prior to contacting the feed stream by heating the supported cobalt catalyst at temperatures of 600° C. to 900° C. for 30 minutes to 5 hours in 4%-10% hydrogen in argon. The gaseous lower alkane can comprise methane.

Also disclosed are processes for preparing a supported catalyst. For example, a process for preparing a supported catalyst as described herein includes providing a support comprising an oxide, impregnating the oxide support with a solution having a cobalt salt, drying the cobalt impregnated oxide support at a temperature ranging from 60° C. to 150° C. to form a supported cobalt catalyst, treating the cobalt catalyst with a boron precursor selected from boric acid, sodium borohydride, ammonium borohydride, or mixtures of these, to form a boron-treated catalyst, and drying the boron-treated cobalt catalyst.

The process includes calcining (heat treating) the dried impregnated support to form the catalyst. The oxide is zirconium oxide. The solution can be an aqueous solution. The drying step is performed at a temperature of from 60° C. to 150° C., from 75° C. to 150° C., and/or the calcining step can be performed at a temperature of 450° C. to 1000° C. Treating the cobalt catalyst with the boron precursor includes stirring for 1-3 hours at 20° C. to 90°.

The process for producing the catalyst includes impregnating the support with a capping agent. Thus, the process for preparing a catalyst as described herein comprises providing a support comprising an oxide, wherein the support is impregnated with a solution comprising a cobalt salt and a surface capping agent. The process also includes treating the impregnated support with a boron precursor and drying the boron-treated impregnated support to form a catalyst.

The oxide is zirconium oxide, cerium oxide, or a mixture of the two oxides. The solution can be an aqueous solution. The surface capping agent can comprise 6-aminohexanoic acid (AHA) or cetyl trimethyl ammonium bromide (CTBA), or a combination thereof. The boron precursor comprises boric acid, sodium borohydride, ammonium borohydride, or a mixture of these. The drying step can be performed at a temperature from 60° C. to 150° C., from about 60° C. to 100° C.

Provided herein are catalyst compositions for use in the production of synthesis gas, which is a gaseous mixture primarily containing hydrogen and carbon monoxide. The synthesis gas is prepared according to a carbon dioxide reforming of methane reaction, which is also known as a dry reforming of methane (DRM) reaction. The catalyst compositions include boron-treated cobalt catalysts disposed on an oxide support. The boron-treated cobalt catalyst systems as described herein show significant increases in the conversion of CH₄ and CO₂ during the dry reforming of methane (DRM) reaction, along with significantly reduced carbon deposition, as compared to traditional catalysts.

The basic catalyst has cobalt in contact with an oxidic support, such as zinc oxide, and the supported cobalt catalyst is then modified with boron precursors. The cobalt catalyst can be disposed on the support by deposition methods, such as impregnation or precipitation, using an aqueous solution of cobalt precursors, such as cobalt nitrate or cobalt chloride. The supported cobalt catalyst can be tuned or modified with an aqueous solution of boron precursors, such as sodium borohydride, ammonium borohydride, boric acid, or combinations thereof, to yield a boron-treated supported cobalt catalyst.

The boron-treated supported cobalt catalysts described herein exhibit excellent stability for an extended reaction time period (e.g., for 150 hours or more of reaction time). The catalyst systems also exhibit resistance to carbon deposition and have an enhanced lifetime. The starting materials for preparing the boron-treated supported cobalt catalyst systems are readily available and are generally of low cost. Thus, the catalyst systems described herein are suitable scale-up catalysts for the carbon dioxide reforming of methane to synthesis gas on an industrial scale.

Catalyst Systems

The catalyst systems described herein include one or more catalyst metal components disposed on an oxide support. The catalyst metal component can include, for example, cobalt, nickel, gold, palladium, platinum, ruthenium, rhodium, osmium, iridium, silver, copper, iron, tungsten, or mixtures thereof. The oxide support can be, for example, zirconium oxide, cerium oxide, silica, aluminum oxide, magnesium oxide, hydrotalcite (Mg—Al—Oₓ), niobia, titanium oxide, tantalum oxide, or tin oxide. The supported catalyst can be modified by a boron precursor compound to form a boron-treated supported catalyst.

The metal catalyst component includes cobalt. Suitable cobalt catalyst precursors are cobalt salts that can dispose cobalt on an oxide support. The cobalt catalyst can be disposed on the support by deposition methods, such as impregnation or precipitation, using an aqueous solution of cobalt precursors, such as cobalt nitrate, cobalt chloride, or mixtures thereof. An exemplary catalyst system includes a supported catalyst that contains cobalt disposed on a zirconium oxide support, which is represented herein as “Co/ZrO₂.”

The amount of cobalt can be from 0.4 wt % to 20 wt % based on the weight of the catalyst. For example, the amount of cobalt can be from 0.5 wt % to 20 wt %, 2 wt % to 20 wt %, or 0.4 wt % to 5 wt %. The amount of cobalt present in the catalyst can be 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt % 16 wt %, 17 wt %, 18 wt %, 19 wt., % or 20 wt %, or any intervening weight, based on the weight of the catalyst

The supported catalyst can be modified by a boron precursor compound to form a boron-treated supported catalyst. Suitable boron precursor compounds include boric acid, sodium borohydride, ammonium borohydride, or any mixture thereof. Exemplary boron treated catalysts include sodium borohydride-treated catalysts and ammonium borohydride treated catalysts.

The boron-treated catalysts are boron-treated cobalt catalysts. The boron-treated cobalt catalysts can include, for example, sodium borohydride-treated cobalt catalysts and ammonium borohydride-treated cobalt catalysts. Exemplary boron-treated cobalt catalysts can include, for example, Co/ZrO₂ (NaBH₄), Co/ZrO₂ (NH₃BH₃), Co/CeO₂ (NaBH₄), Co/CeO₂—ZrO₂ (NaBH₄), or any mixture thereof. The catalyst systems can further comprise one or more non-boron treated catalysts. For example, the catalyst systems can further comprise Co/ZrO₂, Co/CeO₂, Co/CeO₂—ZrO₂, or any mixture thereof.

The amount of boron in the catalyst can be from 0.001 wt % to 0.5 wt % based on the weight of the catalyst. For example, the amount of boron can be from 0.005 wt % to 0.5 wt %, from 0.01 wt % to 0.4 wt %, from 0.05 wt % to 0.3 wt %, from 0.1 wt % to 0.2 wt %. The amount of boron present in the catalyst can be 0.001 wt %, 0.002 wt %, 0.003 wt %, 0.004 wt %, 0.005 wt %, 0.006 wt %, 0.007 wt %, 0.008 wt %, 0.009 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.15 wt %, 0.2 wt %, 0.25 wt %, 0.3 wt %, 0.35 wt %, 0.4 wt %, 0.45 wt %, or 0.5 wt %, or any intervening weight.

The ratio of boron to cobalt present in the catalyst can range from 0.01:1 to 0.5:1. For example, the ratio of boron to cobalt present in the catalyst can range from 0.02:1 to 0.4:1 or from 0.04:1 to 0.3:1, or any ratio therebetween.

Process for Making the Catalysts

Processes for making the catalysts for use in the catalyst systems are also described herein. The catalysts can be prepared using catalyst synthesis methods such as impregnation, spray drying, precipitation, incipient wetness, ion exchange, fluid bed coating, or physical or chemical vapor deposition.

The process for preparing a catalyst as described herein includes an impregnation method. For example, the process can include providing a support comprising an oxide, impregnating the oxide support with a solution including a catalyst metal salt (e.g., a cobalt salt), drying the impregnated support, calcining the impregnated dried support to form a catalyst, and treating the catalyst with a boron precursor to form a boron-treated catalyst.

Catalyst metal salts may be cobalt salts. Exemplary cobalt salts are cobalt (II) chloride hexahydrate (CoCl₂.6H₂O), cobalt nitrate hexahydrate (Co(NO₃)₂.6H₂O), and combinations thereof. Other metal salts, including other cobalt salts can be utilized in the described method. The solution including the catalyst metal salt can be, for example, an aqueous solution. The solvent in the solution is water. The mixture can be stirred at an elevated temperature for a period of time, or the mixture can be stirred at room temperature for a period of time.

Exemplary oxides are zirconium oxide, cerium oxide, or a combination of these oxides. The oxide support can be pre-calcined prior to the impregnation step. The pre-calcining step can be performed at a temperature from 450° C. to 1000° C. (e.g., from 500° C. to 900° C., from 550° C. to 800° C., or from 600° C. to 700° C.) for up to 20 hours.

The step of drying the impregnated support can be performed by mixing the components at an elevated temperature. The step of drying the impregnated support is performed at a temperature of from 60° C. to 150° C. For example, the step of drying the impregnated support can be performed at a temperature of 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., or 150° C. The drying step can be performed for a period of up to 3 hours (e.g., 30 minutes, 1 hour, 2 hours, 3 hours, or any amount of time between these values).

Following the drying step, a calcining step can be performed at a temperature of at least 450° C. for a period of time sufficient to achieve calcination of the material. The calcining step is performed at a temperature of from 450° C. to 1000° C., from 500° C. to 900° C., from 550° C. to 800° C., or from 600° C. to 700° C. In some examples, the heat treatment is performed for a period up to 20 hours (e.g., from 30 minutes to 20 hours, from 1 hour to 15 hours, or from 2 hours to 10 hours). The calcining step can be performed in air, under oxygen, under an inert gas (e.g., nitrogen, argon, or helium), or any combination thereof.

The catalyst can then be treated with a boron precursor (e.g., boric acid, sodium borohydride, ammonium borohydride, or a mixture thereof) to form a boron-treated catalyst. The treatment can be performed by mixing the catalyst in water, adding a solution of the boron precursor to the catalyst mixture, and stirring the resulting mixture at a temperature ranging from room temperature (RT=20-25° C.) up to 90° C. After mixing for a period of time (e.g., up to 1 hour, up to 2 hours, up to 3 hours, up to 4 hours, up to 5 hours, or any period of time up to 5 hours), the resulting product can be washed with a solvent (e.g., water) and dried at an elevated temperature of from 75° C. to 150° C. for up to 24 hours.

The catalyst can be prepared using an impregnation method in the presence of a surface capping agent. The surface capping agent can aid in the attachment of the metal (e.g., cobalt) to the support. The process includes providing a support comprising an oxide, impregnating the support with a solution comprising a cobalt salt and a surface capping agent, treating the impregnated support with a boron precursor, and drying the boron-treated impregnated support to form a catalyst. Exemplary surface capping agents are 6-aminohexanoic acid (AHA) or cetyl trimethyl ammonium bromide (CTBA), or a combination thereof.

Suitable oxides are zirconium oxide, cerium oxide, or a combination of these oxides. The solution including the catalyst metal salt and the surface capping agent can be, for example, an aqueous solution. The solvent in the solution is water. Suitable surface capping agents include 6-aminohexanoic acid (AHA) cetyl trimethyl ammonium bromide (CTBA), or combinations thereof. The mixture can be stirred at an elevated temperature for a period of time to form an impregnated support. The elevated temperature for forming the impregnated support can be from 75° C. to 150° C. For example, the step of impregnating the support can be performed at a temperature of 75° C., 80° C., 85° C., 90° C., 95° C., 100° C., 105° C., 110° C., 115° C., 120° C., 125° C., 130° C., 135° C., 140° C., 145° C., or 150° C. The impregnating the support step can be performed for a period of up to 3 hours (e.g., 30 minutes, 1 hour, 2 hours, or 3 hours).

The impregnated support can then be treated with a boron precursor (e.g., boric acid, sodium borohydride, ammonium borohydride, or a mixture thereof) to form a boron-treated catalyst. The treatment can be performed by stirring the catalyst in water at an elevated temperature (e.g., from 75° C. to 150° C.) and adding a solution of the boron precursor to the catalyst mixture. After mixing for a period of time (e.g., up to 5 hours or any time up to 5 hours), the resulting product can be washed with a solvent (e.g., water and/or acetone) and dried at an elevated temperature of from 60° C. to 100° C. (or any intervening temperature) for up to 24 hours (or any amount of time up to 24 hours).

Exemplary methods for synthesizing the compounds as described herein are provided in Examples 1 and 2 below.

Methods of Use

The catalysts and catalyst systems described herein can be used in a hydrocarbon conversion process to prepare synthesis gas. The hydrocarbon conversion process can be performed using carbon dioxide reforming of lower alkanes to synthesis gas.

Catalysts that are in an oxidized state can be reduced prior to using the catalyst in a hydrocarbon conversion reaction. The reducing step can include subjecting the catalyst to a gas stream prior to using the catalyst in a hydrocarbon conversion reaction. The gas stream can include, for example, hydrogen, nitrogen, air, argon, or combinations of these. The catalyst can be reduced for a period of time of up to 5 hours. For example, the catalyst can be reduced for a period of from 30 minutes to 5 hours (e.g., 30 minutes, 1 hour, 2 hours, 3 hours, 4 hours, or 5 hours). The step of reducing the catalyst can be performed at a temperature of from 600° C. to 900° C. (e.g., 750° C.).

The process for carbon dioxide reforming or steam reforming of lower alkanes to synthesis gas includes contacting a feed stream comprising a gaseous lower alkane and carbon dioxide with a catalyst as described herein. The resulting synthesis gas includes hydrogen and carbon monoxide. The contacting step can be performed at a temperature of from 600° C. to 950° C. (or any temperature in between) and a pressure ranging from 1 bar to 30 bar (or any value in between).

The molar ratio of hydrogen to carbon monoxide obtained according to this process can be from about 0.65 to 1.0. For example, the molar ratio of hydrogen to carbon monoxide can be 0.65:1, 0.7:1, 0.75:1, 0.8:1, 0.85:1, 0.9:1, 0.95:1, or 1:1.

The conversion of the gaseous lower alkane (e.g., methane) is greater than 60 mol % (e.g., greater than 70 mol %, greater than 80 mol %, or greater than 90 mol %). The conversion of carbon dioxide is greater than 60 mol % (e.g., greater than 70 mol %, greater than 80 mol %, or greater than 90 mol %).

The examples below are intended to further illustrate certain aspects of the methods and compositions described herein, and are not intended to limit the scope of the claims.

### EXAMPLES

Cobalt (II) chloride hexahydrate (CoCl₂.6H₂O, 99.999%), cobalt nitrate solution (Co(NO₃)₂.6H₂O, <99%), 6-aminohexonic acid (H₂N(CH₂)₅CO₂H, >98.5%), and sodium borohydride (NaBH₄, 99.999%) were purchased from Sigma-Aldrich and used without further purification. ZrO₂ (specific surface area 70 m² g⁻¹) was purchased from DAIICHI KIGENSO KAGAKU KOGYO CO., LTD. Prior to use, ZrO₂ was pre-calcined at 850° C. for 20 hours with a specific surface area (10 m² g⁻¹).

### Example 1: Preparation of Co/ZrO₂ (NaBH₄) Catalyst by the Impregnation Method

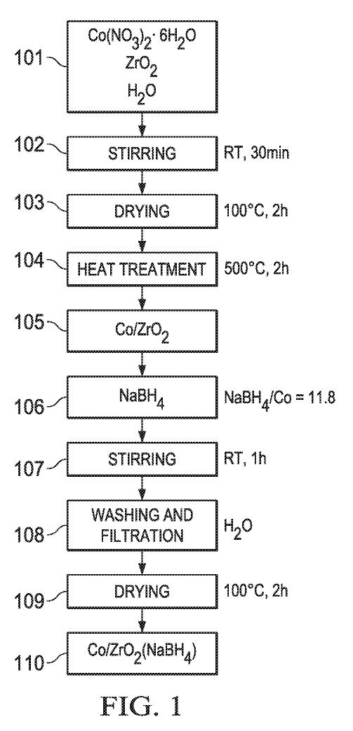

Supported cobalt catalysts promoted with boron were prepared by the impregnation method. A ZrO₂ support was combined with aqueous cobalt nitrate to make various cobalt loadings of 2 to 20 wt %, and then the supported catalyst was treated with sodium borohydride. An exemplary synthetic procedure is shown in the FIG. 1 schematic, as detailed below.

For a 20 wt % Co/ZrO₂ catalyst, 1.975 g of cobalt (II) precursor was dissolved in 200 μL of deionized water, and 2 g of pre-calcined ZrO₂ was added to the cobalt solution (101). The solution was gently mixed with stirring (102) for 30 minutes at room temperature (RT). The mixed sample was dried (103) for 2 hours at 100° C. in an oven and subsequently calcined (104) at 500° C. for 2 hours in a muffle furnace under static air conditions resulting in a cobalt catalyst on a ZrO₂ support (Co/ZrO₂) (105).

The cobalt catalyst supported on ZrO₂ (Co/ZrO₂) (105) was then treated with sodium borohydride (106), with a NaBH₄ to Co molar ratio of 11.8. Typically, 0.4 g of 20 wt % Co/ZrO₂ catalyst prepared by the impregnation method was added into 80 mL of deionized water and vigorously stirred at RT for 1 hour. NaBH₄ (0.606 g) dissolved in 20 mL of deionized water, (held at 8° C.), was added into the solution of dispersed Co/ZrO₂ catalyst and subsequently stirred (107) for 1 hour at room temperature (RT). The sample was then filtered and washed (108) with excess water and dried (109) at 100° C. for 2 hours to result in the final Co/ZrO₂ (NaBH₄) catalyst (110).

Times and temperatures described for the stirring and drying steps of the exemplary synthetic procedure herein are examples only, and are not limited to the times and temperatures in the example. Stirring times vary from 1 minute to 5 hours, inclusive of any time therebetween. Stirring temperatures vary from 10° C. to 50° C., inclusive of any temperature therebetween. Drying times vary from 30 minutes to 3 hours, inclusive of any time therebetween. Drying temperatures vary from 60° C. to 150° C., inclusive of any temperature therebetween.

Catalysts prepared by this method can used without any additional heat treatment, or the catalysts can be reduced by heating prior to use. Cobalt loadings were adjusted by controlling the amount of cobalt precursors. Specifically, 0.198 g of cobalt precursor was used for the 2 wt % Co/ZrO₂ (NaBH₄) catalyst, 0.494 g of cobalt precursor was used for the 5 wt % Co/ZrO₂ (NaBH₄) catalyst, and 0.988 g of cobalt precursor was used for the 10 wt % Co/ZrO₂ (NaBH₄) catalyst.

### Example 2: Preparation of Co/ZrO₂ Catalysts with a Surface Capping Agent

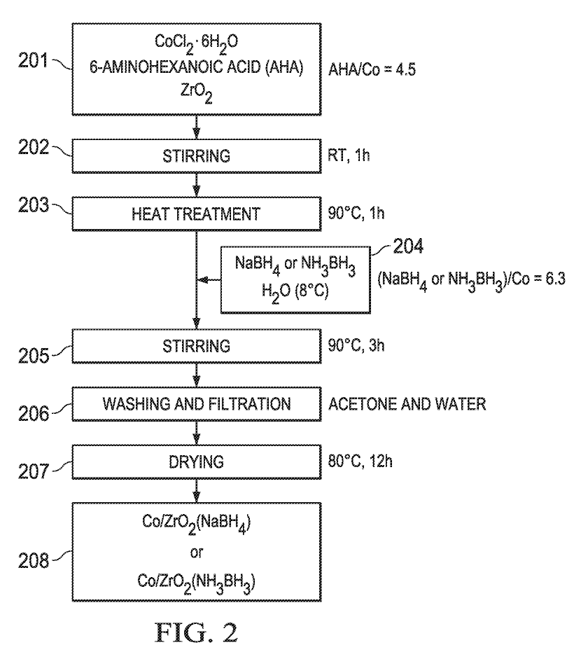

Supported cobalt catalysts were also prepared via impregnation in the presence of 6-aminohexonic acid (AHA). AHA has amino and carboxyl groups, wherein the amino group can work as a surface-capping agent for the cobalt metal particles, and anchoring to the support by the carboxyl group. Alternatively, cetyl trimethyl ammonium bromide (CTBA), alone or in combination with 6-aminohexonic acid (AHA), can be used as the surface capping agent. An exemplary synthetic procedure is shown in the FIG. 2 schematic, as described below:

For a 2 wt % Co/ZrO₂ catalyst, 0.1 g of cobalt (II) chloride hexahydrate and 0.25 g of AHA were dissolved in 50 mL of deionized water and 1 g of pre-calcined ZrO₂ was added to the cobalt solution (201). The AHA/Co ratio is 4.5. The solution was vigorously stirred (202) at RT for 1 hour. The mixture was heated (203) to 90° C. and held for 1 hour. NaBH₄ (0.1 g) dissolved in 20 mL of deionized water (which was kept at 8° C.) was added (204) into the mixture and stirred (205) for 3 hours at 90° C.

The ratio of NaBH₄/Co is 6.3. Once sodium borohydride was added into the cobalt solution, the color immediately changed from pink to black because of the reduction of the cobalt species by hydrogen. The color of the solution changed to dark-green after the reaction completed. The sample was filtered and washed (206) twice with acetone and water and dried (207) at 80° C. for 12 hours to result in the final Co/ZrO₂ (NaBH₄) catalyst (208). NH₃BH₃ is utilized as the boron treatment agent (204) in place of NaBH₄, resulting in a Co/ZrO₂ (NH₃BH₃) catalyst (208).

The catalysts prepared by this method can be used without any additional heat treatment, or the catalysts can be reduced by heating prior to use. Cobalt loadings were adjusted by controlling the amount of ZrO₂ support. Specifically, 4.5 g ZrO₂ was used for the 0.5 wt % Co/ZrO₂ (NaBH₄) catalyst, 0.2 g of ZrO₂ was used for the 1 wt % Co/ZrO₂ (NaBH₄) catalyst, and 0.45 g of ZrO₂ was used for the 5 wt % Co/ZrO₂ (NaBH₄) catalyst.

The procedure shown in FIG. 2, and described above, can be utilized to prepare Co/ZrO₂ (NH₃BH₃) catalysts, wherein NH₃BH₃ replaces NaBH₄ at the same ratio of 6.3. Cetyl trimethyl ammonium bromide (CTBA), alone or in combination with 6-aminohexonic acid (AHA), can be used as the surface capping agent in the procedure described above.

### Example 3: Effects of NaBH₄ Treatment on Catalytic Performance for CO₂ Reforming of Methane

Reactions for carbon dioxide reforming of methane reactions to produce synthesis gas were performed by contacting a feedstream of methane and carbon dioxide with 50 mg of catalyst prepared according to the procedure described in Example 1. The first catalyst system included 0.091 wt % of boron containing Co/ZrO₂ and 8.0 wt % of Co/ZrO₂. The second catalyst system included 8.4 wt % Co/ZrO₂. The catalysts were pretreated by heating at 750° C. for 1 hour in 10% hydrogen in argon to reduce the catalysts. The carbon dioxide reforming reaction was performed at 750° C. using a feedstream of methane (10 kPa) and carbon dioxide (10 kPa). The total pressure of the feed stream was 101 kPa, balanced by argon at a space velocity of 120 L g⁻¹h⁻¹.

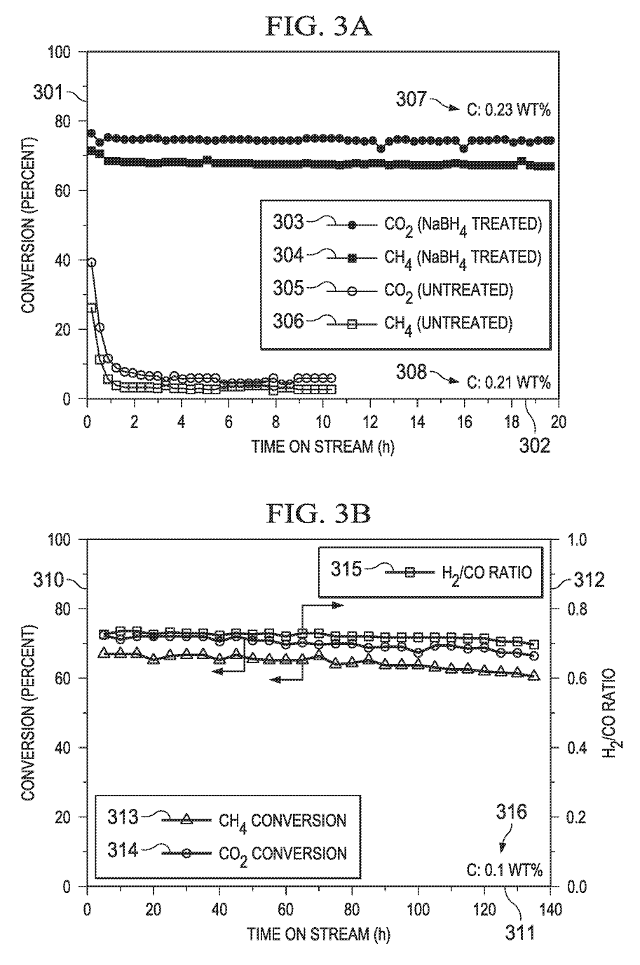

As shown in FIG. 3A, the boron-treated supported cobalt catalyst resulted in a much higher percent of methane conversion consistent over a longer time period than the non-boron-treated catalyst. The FIG. 3A graph shows conversion percentage (301) plotted over time (302).

The boron-treated catalyst consistently yielded methane (304) conversion around 65% and carbon dioxide (303) conversion around 75% over the entire 20 hours on stream. The non-boron-treated catalyst yielded methane (306) conversion of less than 30% to start and carbon dioxide (305) conversion of less than 40% to start with both rapidly dropping to less than 10% around the first hour on stream. The reaction run with the boron-treated catalyst system resulted in 0.23 wt % of deposited carbon (307) after the reaction. The reaction run with the non-boron-treated catalyst system resulted in 0.21 wt % of deposited carbon (308) after the reaction.

In FIG. 3B graphs, the conversion percentages (310) of methane and carbon dioxide over time (311) is shown with the corresponding Hz/CO ratios (312) plotted on the same graph. The boron-treated catalyst had a high conversion percentage of methane (313) and carbon dioxide (314) with greater than 60% conversion realized over 140 hours of reaction time, along with Hz/CO ratios (615) around 0.70 to 0.75. The amount of deposited carbon (316) after the reaction was very low at 0.1 wt %.

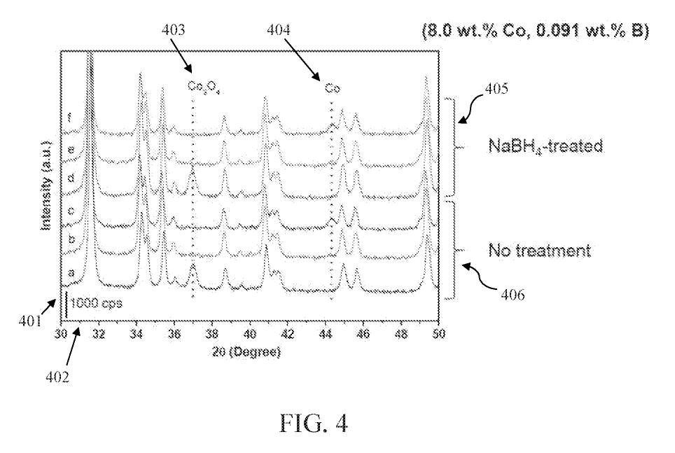

FIG. 4 shows the characterization of the crystalline nature of the first (treated) and second (untreated) catalyst systems as described above using X-ray powder diffraction (XRD) analysis. The intensity (401) in a.u. (arbitrary units) is plotted against 2 theta degrees (402) with reference points indicated for Co₃O₄ (403) and Co (404). Plots a, b, and c (406) on the lower portion of the graph show the XRD patterns for the non-treated catalyst system that included 8.4 wt % Co/ZrO₂ (i.e., the boron-unpromoted catalyst), and plots d, e, and f (405) on the upper portion of the graph show the XRD patterns for the treated catalyst system that comprised 0.091 wt % of boron containing Co/ZrO₂ and 8.0 wt % of Co/ZrO₂ (i.e., the boron-promoted catalyst).

The catalyst characterizations during the preparation step after calcination at 500° C. for 1 hour under air flow are shown in plots a and d. The catalyst characterizations after the reduction of the catalysts at 750° C. for 1 hour under H₂ flow are shown in plots b and e. The catalyst characterizations after the CO₂ reforming of methane at 750° C. for 10 hours are shown in plots c and f. Following reduction, the deffractograms in plots b and e show a decrease in Co₃O₄ for both the boron-treated and boron-untreated catalysts, which remains consistent in plots c and f for the catalysts following CO₂ reforming.

### Example 4: Effects of Boron Source on Catalytic Performance for CO₂ Reforming of Methane

Carbon dioxide reforming of methane reactions to produce synthesis gas were performed by contacting a feedstream of methane and carbon dioxide with 50 mg of catalyst systems prepared according to the procedure described in Example 2. The first catalyst system was a boron-unpromoted catalyst that included 2.0 wt % of Co/ZrO₂. The second catalyst system was a 2.0 wt % Co/ZrO₂ (NaBH₄) catalyst that included 0.022 wt % B and had a B/Co ratio of 0.060.

The third catalyst system was a 2.0 wt % Co/ZrO₂ (NH₃BH₃) catalyst that included 0.020 wt % B and had a B/Co ratio of 0.055. The catalysts were pretreated by heating at 750° C. for 1 hour in 10% hydrogen in argon to reduce the catalysts. The carbon dioxide reforming reaction was performed at 750° C. using a feedstream of methane (10 kPa) and carbon dioxide (10 kPa). The total pressure of the feed stream was 101 kPa, balanced by argon at a space velocity of 120 L g⁻¹h⁻¹.

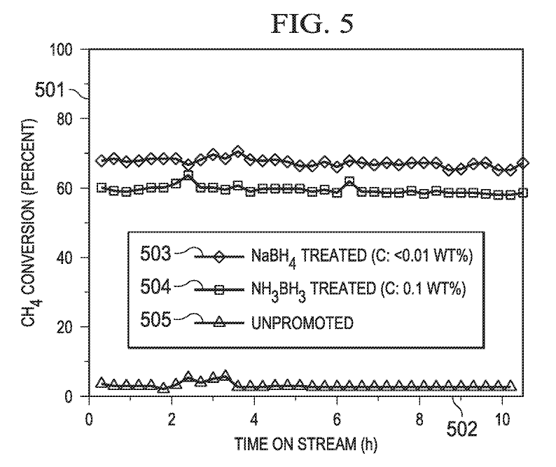

As shown in FIG. 5, both of the boron-treated catalysts resulted in a higher percentage conversion of methane than the non-boron-treated catalyst. Conversion percentage for methane (501) was plotted against time (502) in hours for untreated and boron-treated catalysts. The reaction run with the 2.0 wt % Co/ZrO₂ (NaBH₄) catalyst system (503) resulted in a methane conversion of greater than 65% to 70% with <0.01 wt % of deposited carbon after the reaction.

The reaction run with the 2.0 wt % Co/ZrO₂ (NH₃BH₃) catalyst system (504) resulted in a methane conversion of approximately 60% with 0.1 wt % of deposited carbon after the reaction. The catalyst that was unpromoted (505) by either boron source resulted in a very low methane conversion of less than 5%. Both of the boron-promoted catalyst systems showed high percentages of methane conversion while producing very little carbon deposition that could foul or deactivate the catalysts indicating the highly advantageous effect of boron-treatment on the catalyst system.

### Example 5: Effects of B/Co Ratio on Catalytic Performance for CO₂ Reforming of Methane

Testing was performed for catalysts prepared according to the procedure described in Example 2, using the pretreatment and dry reforming of methane (DRM) reaction conditions described in Example 4.

The catalysts shown in Table 1, below, were prepared.

TABLE 1

| Co (wt %) | B (wt %) | B/Co Ratio |
|---|---|---|
| 0.43 | 0.016 | 0.203 |
| 1.1 | 0.027 | 0.134 |
| 2.0 | 0.020 | 0.055 |
| 3.9 | 0.032 | 0.045 |

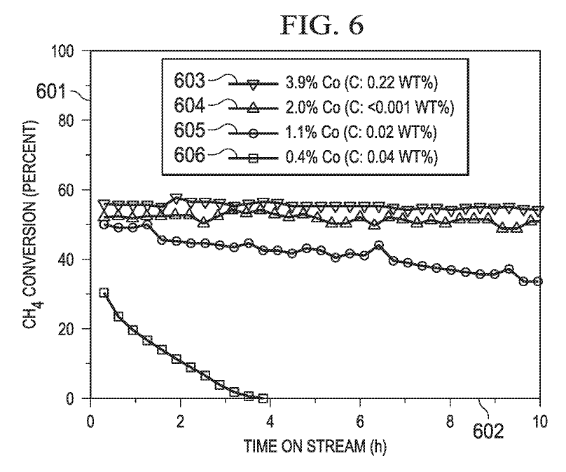

In FIG. 6, the percentage of methane conversion (601) is plotted against time (602) for the catalyst systems in Table 1. The boron-treated catalyst containing 3.9 wt % Co and a B/Co ratio of 0.045 (603) resulted in the highest percentage conversion of methane as compared to the other catalyst systems of Table 1 with conversion percentages greater than 55% maintained over the 10 hours of the test run.

Methane conversion for the boron-treated catalyst containing 2.0 wt % Co and a B/Co ratio of 0.055 (604) was more than 50% over the 10 hour test run. The boron-treated catalyst containing 1.1 wt % Co and a B/Co ratio of 0.134 (605) had a conversion percentage of around 50% for the first 2 hours, but gradually decreased over time. The boron-treated catalyst containing 0.43 wt % Co and a B/Co ratio of 0.203 (606) resulted in the lowest percentage conversion of methane compared to the other catalyst systems of Table 1 with a starting conversion of 30% that rapidly decreased to near zero by 4 hours. Each of the boron-treated catalysts had very low amounts of carbon deposition with the 3.9 wt % Co, 2.0 wt % Co, 1.1 wt % Co and 0.43 wt % Co, producing 0.22%, <0.001%, 0.02% and 0.04% carbon residue, respectively.

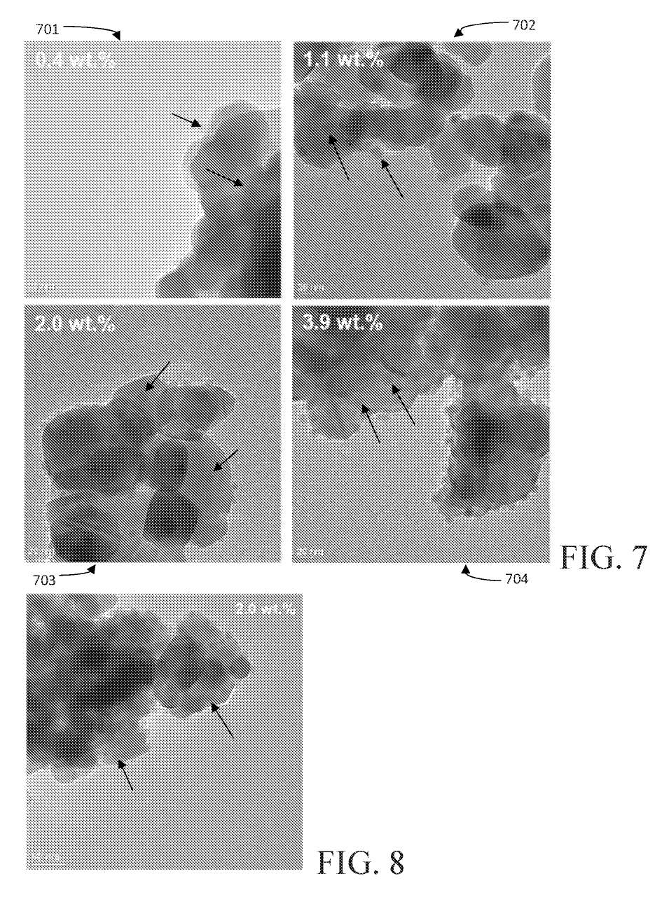

Transmission electron microscopy (TEM) images were taken for the catalysts of Table 1 after pretreatment to reduce the catalysts and before the dry reforming of methane (DRM) reaction. FIG. 7 shows TEM images for the 0.43 wt % Co catalyst (701), 1.1 wt % Co catalyst (702), 2.0 wt % Co catalyst (703) and 3.9 wt % Co catalyst (704) taken after reduction. The pretreatment was performed by heating the catalysts at 750° C. for 1 hour in 4% hydrogen in argon (100 cm³/min) to reduce the catalysts. Arrows on the images indicate cobalt particles distributed in the catalyst system. The number of cobalt particles visible increase as the weight percent of the cobalt in the catalyst increases.

FIG. 8 is a TEM image taken after the dry reforming of methane (DRM) reaction for the Table 1 catalyst with 2.0 wt % Co and a Bo/C ratio of 0.055.

### Example 6: Effects of CeO₂ and CeO₂—ZrO₂ Supports for NaBH₄ Treated Cobalt Catalysts for CO₂ Reforming of Methane

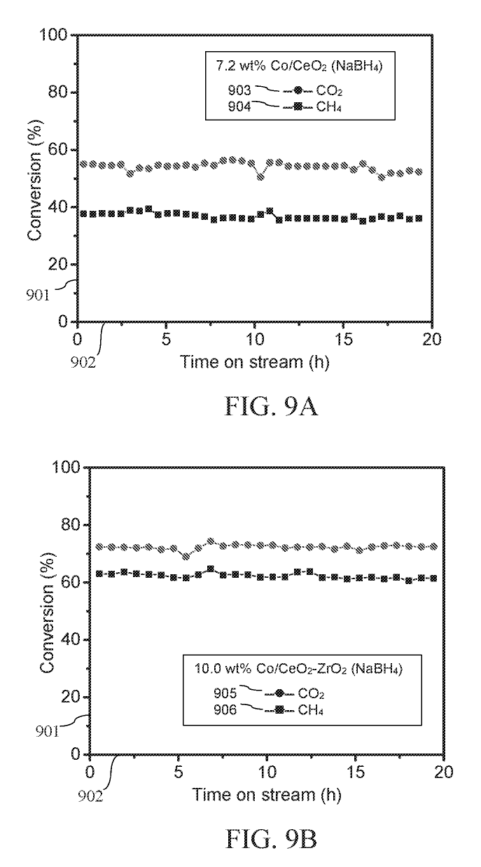

Boron-treated cobalt catalysts were prepared using cerium oxide and a cerium oxide-zirconium oxide combination as the oxide supports according to the procedure described in Example 1. Reactions for carbon dioxide reforming of methane to produce synthesis gas were performed by contacting a feed stream of methane and carbon dioxide with 50 mg of each catalyst over a time period of 20 hours. FIGS. 9 A and 9B are graphs showing the conversion percentages (901) over time on stream (902) for methane and carbon dioxide using boron-treated cobalt catalysts on the cerium oxide and cerium oxide/zirconium oxide supports. Both catalysts were pretreated by heating at 750° C. for 1 hour in 10% hydrogen in argon to reduce the catalysts. The carbon dioxide reforming reaction was performed at 750° C. using a feed stream of methane (10 kPa) and carbon dioxide (10 kPa). The total pressure of the feed stream was 101 kPa, balanced by argon at a space velocity of 120 L g⁻¹h⁻¹.

The FIG. 9A graph shows results for the cerium oxide supported catalyst system with 7.2 wt % of Co/CeO₂ (NaBH₄). Using the cerium oxide supported catalyst, conversion of methane (904) was around 35-40% and conversion of carbon dioxide (903) was around 50-55% over the 20 hour reaction period.

The FIG. 9B graph shows results for the cerium oxide/zirconium oxide supported catalyst system with 10.0 wt % of Co/CeO₂—ZrO₂ (NaBH₄). Using the cerium oxide/zirconium oxide combination supported catalyst, conversion of methane (905) was around 60-65% and conversion of carbon dioxide (906) was around 70-75% over the 20 hour reaction period.

The results demonstrate that CeO₂ and CeO₂—ZrO₂ supported catalysts have conversion percentages comparable to the catalyst systems supported by zirconium oxide. ZrO₂, CeO₂ and CeO₂/ZrO₂ combinations are suitable oxide supports for the disclosed boron-treated cobalt catalysts for use in processes for reforming methane to synthesis gas.

The compounds and methods of the appended claims are not limited in scope by the specific compounds and methods described herein, which are intended as illustrations of a few aspects of the claims and any compounds and methods that are functionally equivalent are within the scope of this disclosure. Various modifications of the compounds and methods in addition to those shown and described herein are intended to fall within the scope of the appended claims.

Further, while only certain representative compounds, methods, and aspects of these compounds and methods are specifically described, other compounds and methods are intended to fall within the scope of the appended claims. Thus, a combination of steps, elements, components, or constituents can be explicitly mentioned herein; however, all other combinations of steps, elements, components, and constituents are included, even though not explicitly stated.

1-15. (canceled)

16. A supported cobalt catalyst for carbon dioxide reforming of lower alkanes to synthesis gas comprising:
a cobalt catalyst; and
an oxide support comprising zirconium oxide, aluminum oxide, magnesium oxide, hydrotalcite (Mg—Al—Oₓ), or titanium oxide;
wherein said supported cobalt catalyst has been modified with a boron precursor comprising sodium borohydride (NaBH₄), ammonium borohydride (NH₃BH₃), boric acid, or a combination thereof.

17. The catalyst of claim 16, wherein the oxide support comprises zirconium oxide (ZrO₂), cerium oxide (CeO₂), or a combination of zirconium oxide and cerium oxide (CeO₂—ZrO₂).

18. The catalyst of claim 16, wherein cobalt is in an amount from 0.4 wt % to 20 wt % based on the weight of the catalyst.

19. The catalyst of claim 16, wherein boron is in an amount from 0.001 wt % to 1.0 wt % based on the weight of the catalyst.

20. The catalyst of claim 16, wherein the cobalt catalyst is prepared from an aqueous solution of cobalt nitrate (Co(NO₃)₂.6H₂O) hexahydrate, cobalt (II) chloride hexahydrate (COCl₂.6H₂O), or combinations thereof.

21. The catalyst of claim 16, wherein the supported cobalt catalyst comprises Co/ZrO₂ (NaBH₄), Co/ZrO₂ (NH₃BH₃), Co/CeO₂ (NaBH₄), Co/CeO₂—ZrO₂ (NaBH₄), or a mixture thereof.

22. The catalyst of claim 16, wherein the catalyst further comprises Co/ZrO₂, Co/CeO₂, Co/CeO₂—ZrO₂, or combinations thereof.

23. A method for preparing a catalyst, comprising:
(a) providing an oxide support;
(b) impregnating the oxide support with a solution comprising a cobalt salt;
(c) drying the cobalt impregnated oxide support at a temperature from 60° C. to 150° C. to form a supported cobalt catalyst;
(d) treating the supported cobalt catalyst with a boron precursor selected from boric acid, sodium borohydride, ammonium borohydride, or a mixture thereof, to form a boron-treated supported cobalt catalyst; and
(e) drying the boron-treated supported cobalt catalyst at a temperature from 60° C. to 150° C.

24. The method of claim 23, wherein the oxide support comprises zirconium oxide (ZrO₂), cerium oxide (CeO₂), or a combination of zirconium oxide and cerium oxide (CeO₂—ZrO₂).

25. The method of claim 23, wherein the solution comprising the cobalt salt is an aqueous solution.

26. The method of claim 23, further comprising the step of calcining the cobalt impregnated oxide support at a temperature of 450° C. to 1000° C. prior to treating with the boron precursor.

27. The method of claim 23, further comprising a surface-capping agent in the solution with the cobalt salt.

28. The method of claim 26, wherein the surface capping agent comprises 6-aminohexanoic acid (AHA), cetyl trimethyl ammonium bromide (CTBA), or a combination thereof.

29. The method of claim 23, wherein the boron-treated supported cobalt catalyst comprises Co/ZrO₂ (NaBH₄), Co/ZrO₂ (NH₃BH₃), Co/CeO₂ (NaBH₄), Co/CeO₂—ZrO₂ (NaBH₄), or a mixture thereof.

30. A method for carbon dioxide reforming of lower alkanes to synthesis gas, comprising:
providing a cobalt catalyst disposed on an oxide support, said cobalt catalyst having been modified by a boron precursor selected from sodium borohydride, ammonium borohydride, boric acid and combinations thereof;
providing a feed stream comprising a gaseous lower alkane and carbon dioxide;
contacting said feed stream with said a catalyst under conditions to produce a synthesis gas; and
collecting the synthesis gas, said synthesis gas comprising hydrogen and carbon monoxide.

31. The method of claim 29, wherein the supported cobalt catalyst is pretreated to reduce the catalyst prior to contacting the feed stream by heating the supported cobalt catalyst at temperatures of 600° C. to 900° C. for 30 minutes to 5 hours in 4%-10% hydrogen in argon.

32. The method of 29, wherein the gaseous lower alkane comprises methane.

33. The method of 29, wherein said conditions to produce synthesis gas comprise contacting said feed stream with said cobalt catalyst at a temperature of 600° C. to 950° C. and a pressure of 1 bar to 30 bar.

34. The method of claim 29, wherein the cobalt catalyst comprises Co/ZrO₂ (NaBH₄), Co/ZrO₂ (NH₃BH₃), Co/CeO₂ (NaBH₄), Co/CeO₂—ZrO₂ (NaBH₄), or a mixture thereof.
